(19) United States
(12) Patent Application Publication
(10) Pub. No.: US 2003/0101090 A1
(43) Pub. Date: May 29, 2003

(54) Method for determining a feature introduction timing plan for a product

(75) Inventors: Eric Heller, Canton, MI (US); Thomas Gary LaWall, Ypsilanti, MI (US); Thomas Ozog, Canton, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/065,733

(22) Filed: Nov. 13, 2002

Related U.S. Application Data
(60) Provisional application No. 60/337,340, filed on Nov. 13, 2001.

(51) Int. Cl. G06F 17/60

(52) U.S. Cl. 705/10

(57) ABSTRACT

A method for determining a feature introduction timing plan has been disclosed. This method includes the step of determining a product attribute leadership strategy for a feature. This method further includes the step of categorizing the feature as one of a number of feature types. The method also includes estimating a first-to-market time for the feature. From this information, a feature introduction timing plan is generated that aligns this information with the overall business goals of a manufacturer. This plan can then be utilized to assess engineering readiness or allocate engineering resources.

### CROSS REFERENCE TO RELATED APPLICATIONS

This application claims priority to Provisional Application No. 60/337,340, which was filed on Nov. 13, 2001 and is incorporated herein by reference.

### BACKGROUND OF INVENTION

1. Technical Field

The present invention relates generally to a method for determining a feature introduction plan of a product, and more particularly, to a method for determining an introduction plan for a feature of a vehicle.

2. Background of the Invention

Manufacturers utilize many strategies for determining when new products, or new features of a product, will be introduced. For example, a manufacturer may assess the resources available to design, manufacture, and test a new feature in order to determine when that feature should be introduced. Alternatively, a decision-maker may arbitrarily set a goal of a certain date by which a new feature will be introduced, and then allocate the resources necessary to accomplish that goal. Each of the strategies above fails to consider important factors when determining when to introduce a new feature in a product.

Many factors may be considered by a manufacturer when determining a feature introduction timing plan. One factor to consider is whether the manufacturer desires to be a leader in the introduction of this feature. A second factor is the date by which competitors plan on offering this new feature or product. Additionally, whether this type of feature meshes well with the intended product and product segment should be considered; the optimal introduction date of a new feature may not be the same across all product segments, for example, the feature introduction date for an expensive option in an economy product should probably be later than the date for that same option in a luxury product. The desired outcome is a feature introduction plan that best suits the manufacturer's business goals.

It would therefore be desirable to provide a method for calculating a feature introduction timing plan based on a feature introduction leadership strategy, the feature category, the intended product segment, and an estimated first-to-market timing.

### SUMMARY OF INVENTION

The present invention provides a method for determining a feature introduction timing plan for a product.

In one aspect of the invention, a method for planning the timing of a feature introduction of a product is disclosed. This method comprises the step of selecting a feature of a product for which a feature introduction timing plan is to be calculated. The method further comprises the steps of estimating a first-to-market timing for the feature and selecting a product attribute leadership strategy (PALS) for the feature based on a desired competitive market timing. The method also comprises the step of retrieving a PALS adjustment factor associated with the PALS from a PALS adjustment factor database. The method comprises the steps of selecting a product segment for the feature and selecting one of a plurality of feature types for the feature. The method further comprises the step of retrieving a segment adjustment factor associated with the product segment and one of the plurality of feature types from a segment adjustment factor database. Additionally, the method comprises the step of calculating the feature introduction timing plan for the feature and the product segment based on the PALS adjustment factor, the segment adjustment factor, and the first-to-market timing. In a further aspect of the invention, a method for planning the timing of a feature introduction of a product is disclosed. This method comprises the steps of: selecting a feature of a product for which a feature introduction timing plan is to be calculated; estimating a first-to-market time for the feature; and generating a feature introduction timing plan for the product based on the first-to-market time, a product attribute leadership strategy, a product segment, and a feature type.

One advantage of the invention is that the timing of the introduction of new features into a product is calculated based on a set process that considers many of the important factors. Another advantage of the invention is that the timing plan is determined by market considerations and business strategies, rather than limitations of engineering resources.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a flowchart of a method for calculating a feature introduction timing plan according to the present invention.

FIG. 2 is an example of a Product Attribute Leadership Strategy adjustment factor database according to the present invention.

FIG. 3 is an example of a segment adjustment factor database according to the present invention.

FIG. 4 is a diagrammatic view of a system for use in conjunction with a method for calculating a feature introduction timing plan according to the present invention.

### DETAILED DESCRIPTION

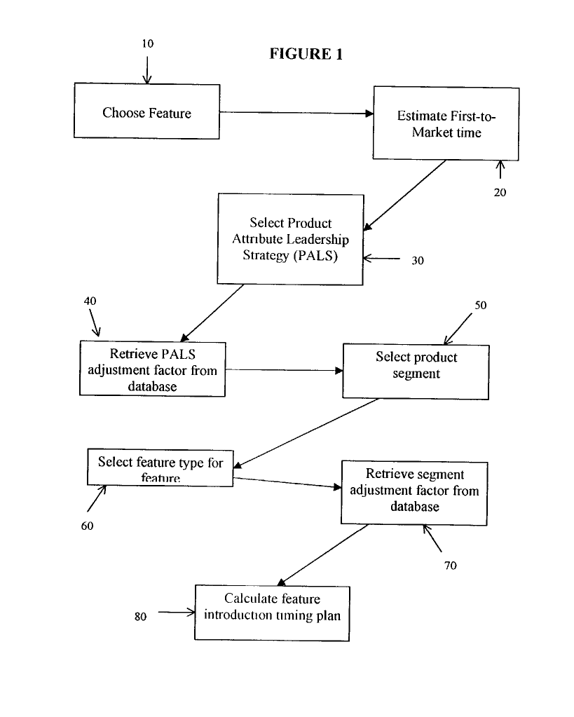

Referring now to FIG. 1, a method for calculating a feature introduction timing plan is disclosed. At step 10, a feature is chosen for which one desires to determine a feature introduction timing plan. At step 20, the time at which the feature will first be introduced to the market (first-to-market time) is estimated. This estimation may be done in various ways, for example, by gathering competitive intelligence or by researching trade journals or marketing materials from suppliers for part offerings relevant to the feature. The estimation may also take into account the usual practice for the timing of new product launches in the market, e.g., new automobiles are usually introduced in the latter part of a year and are given the model year of the following year. The first-to-market time is preferably an actual date, but may also be expressed as a period of time from the date of the estimation.

In step 30, a product attribute leadership strategy (PALS) is determined for the feature. The PALS is a description of the desired competitive timing for the manufacturer to introduce the feature. In a preferred embodiment, the PALS can be one of the following four options: Leader; Among the Leaders; Competitive; or Uncompetitive, however additional (or fewer) PALS options may be offered. The PALS determination may take into account many factors, including the importance of that feature to the manufacturer's products, the ability of that feature to increase sales or profits of the product, the consumer demand for such a feature, and the manufacturer's desire to be known as an innovator for that feature in its industry. Preferably, the PALS is individually determined for the specific feature at issue, however, in another embodiment a PALS is chosen for a category of features and the category of the feature automatically determines the PALS. For example, a vehicle manufacturer may determine that it wishes to be a Leader in offering powerful engines in the industry. Any feature in the increased engine power category would automatically receive a PALS of Leader in this example.

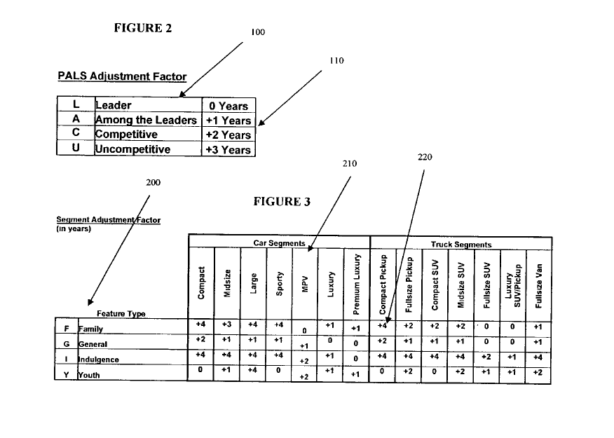

Once the PALS is determined for the feature, a PALS adjustment factor is retrieved from a PALS adjustment factor database based on that PALS in step 40. The PALS adjustment factor database, an example of which is shown in FIG. 2, associates every possible PALS with a PALS adjustment factor. In FIG. 2, a plurality of PALS 100 is shown on the left of the table. The various PALS adjustment factors 110 are shown on the right of the table corresponding with the PALS 100. The PALS adjustment factor is preferably an amount of time to be added to (or subtracted from) the first-to-market time when calculating the feature introduction timing plan, as discussed below. However, the PALS adjustment factor may also be a multiplication factor.

As shown in FIG. 2, in a preferred embodiment a PALS 100 of “Leader” would correspond with a PALS adjustment factor 110 of 0, indicating that the manufacturer should not delay the feature introduction timing plan because the strategy for that feature is to be a market leader. Similarly, if the PALS 100 is Competitive, the PALS adjustment factor 110 is +2 Years. The PALS 100 and PALS adjustment factors 110 are logically related such that the PALS adjustment factor 110 furthers the pursuit of the desired strategy, i.e., PALS 100. The manufacturer could choose a PALS, for example, by estimating expected profits and/or gain in market share, based on market research, and/or by other marketplace considerations.

Referring again to FIG. 1, at step 50 a product segment in which the feature is to be included is chosen. Examples of product segments in the automobile industry include compact car, luxury car, full-size pickup truck, and full-size sport-utility vehicle. At step 60, the feature is categorized as a feature type. In a preferred embodiment the feature type is at least tangentially related to what type of consumer to which the feature would appeal. Preferred examples of feature types include Family, General, Indulgence, and Youth, however additional (or fewer) options may be available.

At step 70, a segment adjustment factor is retrieved from a segment adjustment factor database based on the product segment from step 50 and the feature type from step 60. The segment adjustment factor database, an example of which is shown in FIG. 3, associates every possible combination of product segment and feature type with a segment adjustment factor. In FIG. 3, a plurality of feature types 200 is shown on the left of the table. At the top of the table, a plurality of product segments 210 is shown. A plurality of segment adjustment factors 220 is shown, each segment adjustment factor 220 corresponding with the intersection of a feature type 200 and a product segment 210 in the table. Similar to the PALS adjustment factor above, the segment adjustment factor is preferably an amount of time to be added to (or subtracted from) the first-to-market time when calculating the feature introduction timing plan, as discussed below, however it may also be a multiplication factor.

As shown in FIG. 3, in a preferred embodiment of the present invention a feature type 200 of Indulgence and a product segment 210 of Compact Car would correspond with a segment adjustment factor 220 of +4 Years, indicating that the manufacturer should delay the introduction of the feature in that product segment 210 by 4 years. The segment adjustment factors 220 are logically related to both the feature types 200 and product segments 210 such that the segment adjustment factors 220 tend to correspond with the business goals of the manufacturer. In this example, the manufacturer believes a feature type 200 of Indulgence and a product segment 210 of Compact Car corresponds to a lengthy delay in the introduction of the feature because a feature that is of the type Indulgence does not suit the Compact Car product segment consumer. The segment adjustment factor database could be generated, for example, by using marketing research, price sensitivities, and/or previous experience.

Once the first-to-market time, PALS adjustment factor, and segment adjustment factor have been determined, the feature introduction timing plan is calculated at step 80. Preferably the feature introduction timing plan is calculated by adding the PALS adjustment factor and segment adjustment factor to the first-to-market time. This yields a date at which the feature should be introduced. Alternatively, the first-to-market time is expressed as a period of time from the date of the estimation (as discussed above) and is multiplied by the PALS adjustment factor and segment adjustment factor to yield a feature introduction timing plan, also expressed as a time period.

In a preferred embodiment, a computer program, for example a spreadsheet program, is utilized to automatically generate a feature introduction timing plan from a limited number of inputs. A user would input a first-to-market time, choose from a selection of PALS 100, e.g., those shown in FIG. 2, and choose from a selection of feature types 200, e.g., those shown in FIG. 3, and the program would automatically generate a feature introduction timing plan for every available product segment.

The manufacturer may use the generated feature introduction timing plan in many ways. For example, the manufacturer may allocate (or reallocate) engineering resources in order to achieve the plan. Alternatively, the manufacturer may compare a generated feature introduction timing plan to a current timing plan in order to see if the current timing plan aligns with the desired PALS for the intended product segment. Additionally, the feature introduction timing plan can be used to assess the engineering readiness for the product.

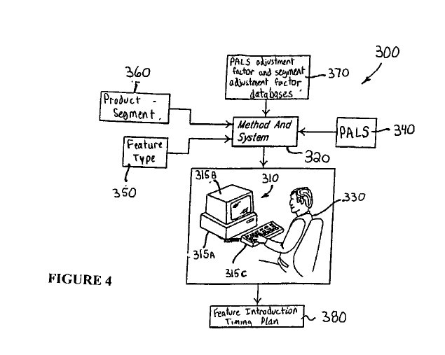

Referring now to FIG. 4, a diagrammatic view of a system for use in conjunction with a method according to the present invention. The system 300 includes a computer system 310, having a processor, a controller, and a memory shown at 315A to process information relevant to the method 320 for determining a feature introduction plan of a product. The computer system 310 includes a display device 315B, such as a video terminal, to display information related to the method.

In this example, information is displayed on the video terminal 315B in a series of screens. Selection and control of the information within a screen can be achieved by the user 330, via a user interactive device 315C, such as a keyboard or a mouse. A user 330 inputs information into the computer system 310 when prompted to do so. The information preferably represents the different alternatives for the PALS 340, feature type 350, and product segment(s) 360. Preferably, a PALS adjustment factor database and a segment adjustment factor database 370 are already stored in the memory of the computer of the computer system 310. The system and method 320 utilizes the information input via user interactive device 315C by the user 330 and the databases 370 stored in the memory of the computer of the computer system 310 to generate the feature introduction timing plan 380 by the method described above. This feature introduction timing plan 380 is preferably output via the display device 315B, but may alternatively be output to another output device, e.g., a computer printer.

While particular embodiments of the invention have been shown and described, numerous variations and alternate embodiments will occur to those skilled in the art. Accordingly, it is intended that the invention be limited only in terms of the appended claims.

1. A method for planning the timing of a feature introduction of a product comprising:
selecting a feature of a product for which a feature introduction timing plan is to be calculated;
estimating a first-to-market timing for said feature;
selecting a product attribute leadership strategy (PALS) for said feature, said PALS based on a desired competitive market timing;
retrieving a PALS adjustment factor associated with said PALS from a PALS adjustment factor database;
selecting a product segment for said feature;
selecting one of a plurality of feature types for said feature;
retrieving a segment adjustment factor associated with said product segment and said one of said plurality of feature types from a segment adjustment factor database; and
calculating said feature introduction timing plan for said feature and said product segment based on said PALS adjustment factor, said segment adjustment factor, and said first-to-market timing.

2. The method of claim 1, further comprising the step of determining an engineering resource allocation based on said feature introduction timing plan.

3. The method of claim 1, wherein said selecting said PALS is based on an expected profit for said product.

4. The method of claim 1, wherein said selecting said PALS is based on a consumer market demand.

5. The method of claim 1, wherein said product comprises an automobile.

6. The method of claim 1, wherein said PALS adjustment factor comprises a time period.

7. The method of claim 1, wherein said calculating said feature introduction timing plan is performed by a computer program.

8. The method of claim 1, further comprising the step of comparing said feature introduction timing plan with a current product timing plan.

9. A method for planning the timing of a feature introduction of a product comprising:
selecting a feature of a product for which a feature introduction timing plan is to be calculated;
estimating a first-to-market time for said feature; and
generating a feature introduction timing plan for said product based on said first-to-market time, a product attribute leadership strategy, a product segment, and a feature type.

10. The method of claim 9, wherein said product attribute leadership strategy is based on a consumer market demand.

11. The method of clam 9, wherein said estimating said first-to-market time comprises gathering competitive intelligence.

12. The method of claim 9, wherein said product attribute leadership strategy is based on an expected increase of sales of said product when said feature is included in said product.

13. The method of claim 9, further comprising the step of choosing said product attribute leadership strategy from a finite set of product attribute leadership strategies.

14. The method of claim 13, further comprising the step of choosing said product segments from a finite set of product segments.

15. The method of claim 14, further comprising the step of choosing said feature type from a finite set of feature types.
